(19) United States
(12) Patent Application Publication
(10) Pub. No.: US 2019/0045404 A1
(43) Pub. Date: Feb. 7, 2019

(54) Method of Multi-Connectivity Configuration

(71) Applicant: MEDIATEK INC., Hsinchu (TW)

(72) Inventors: Chun-Fan Tsai, Hsinchu (TW); Yih-Shen Chen, Hsinchu (TW)

(21) Appl. No.: 16/053,799

(22) Filed: Aug. 3, 2018

Related U.S. Application Data
(60) Provisional application No. 62/541,183, filed on Aug. 4, 2017.

(51) Int. Cl. H04W 36/00; H04W 76/16; H04W 88/06; H04W 24/10; H04W 76/19

(52) U.S. Cl. CPC H04W 36/0022; H04W 76/16; H04W 36/0088; H04W 24/10; H04W 76/19; H04W 88/06

(57) ABSTRACT

A method of supporting fast dual connectivity (DC) configuration after fallback in a 4G/5G network is proposed. A UE is configured with MR-DC (Multi-RAT Dual Connectivity) and is connected to both LTE/NR RAT in LTE/NR serving cells of master cell group (MCG) and secondary cell group (SCG). The UE has to fall back to legacy 2G/3G RAT and is forced to release the DC configuration. The UE records the serving cell information before fallback procedure and sends assistant information of the DC configuration to the network after fallback procedure. The assistant information comprises the stored serving cell information and optional additional measurement results for candidate SCG cells. The assistant information allows the network to resume the highspeed data transmission soon after the fallback procedure.

### CROSS REFERENCE TO RELATED APPLICATION

This application claims priority under 35 U.S.C. § 119 from U.S. Provisional Application No. 62/541,183, entitled “Method of Multi-Connectivity Configuration,” filed on Aug. 4, 2017, the subject matter of which is incorporated herein by reference.

### TECHNICAL FIELD

The disclosed embodiments relate generally to wireless communication systems, and, more particularly, to user equipment (UE) supporting fast dual connectivity (DC) configuration after fallback.

### BACKGROUND

3GPP Long-Term Evolution (LTE) systems offer high peak data rates, low latency, improved system capacity, and low operating cost resulting from simple network architecture. A 3GPP LTE system also provides seamless integration to older wireless network, such as GSM, CDMA and Universal Mobile Telecommunication System (UMTS). Enhancements to LTE systems are considered so that they can meet or exceed IMA-Advanced fourth generation (4G) standard. One of the key enhancements is to support bandwidth up to 100 MHz and be backwards compatible with the existing wireless network system. In LTE/LTE-A systems, an evolved universal terrestrial radio access network (E-UTRAN) includes a plurality of evolved Node-Bs (eNBs) communicating with a plurality of mobile stations, referred as user equipments (UEs).

The signal bandwidth for next generation 5G new radio (NR) system is estimated to increase to up to hundreds of MHz for below 6 GHz bands and even to values of GHz in case of millimeter wave bands. Furthermore, the NR peak rate requirement can be up to 20 Gbps, which is more than ten times of LTE. Three main applications in 5G NR system include enhanced Mobile Broadband (eMBB), Ultra-Reliable Low Latency Communications (URLLC), and massive Machine-Type Communication (MTC) under milli-meter wave technology, small cell access, and unlicensed spectrum transmission. Multiplexing of eMBB & URLLC within a carrier is also supported.

Dual Connectivity (DC) architecture is introduced in LTE R12 to increase the UE throughput. This architecture allows UE to utilize the radio resource for two nodes. Multi-RAT Dual Connectivity (MR-DC) architecture is further introduced in 5G. The UE could use radio resource provided by different RAT under MR-DC architecture. In DC mode, UE is connected to one node (eNB/gNB) as Master Node (MN) and one node (eNB/gNB) as Secondary Node (SN). Multiple serving cells are configured for the UE in DC mode. The serving cell from MN is defined as Master Cell Group (MCG). The subset of serving cells that do not belong to MCG is defined as Secondary Cell Group (SCG). EN-DC (EUTRAN-NR Dual Connectivity) is one possibility for MR-DC and is likely to be deployed in 5G.

However, if UE has fallback to legacy RAT (e.g., 2G/3G) network for some specific purpose (e.g., for CSFB voice call), the DC configuration is forced to be released. After the fallback procedure is completed (e.g., the voice call ended), the UE could return to a cell from the original MCG cells. But UE has to wait the network configuration for adding the cells of SCG. It will take some time for the network to do the reconfiguration and bring UE back to DC mode.

A solution is sought.

### SUMMARY

A method of supporting fast dual connectivity (DC) configuration after fallback in a 4G/5G network is proposed. A UE is configured with MR-DC (Multi-RAT Dual Connectivity) and is connected to both LTE/NR RAT in LTE/NR serving cells of master cell group (MCG) and secondary cell group (SCG). The UE has to fall back to legacy 2G/3G RAT and is forced to release the DC configuration. The UE records the serving cell information before fallback procedure and sends assistant information of the DC configuration to the network after fallback procedure. The assistant information comprises the stored serving cell information and optional additional measurement results for candidate SCG cells. The assistant information allows the network to resume the highspeed data transmission soon after the fallback procedure.

In one embodiment, a UE establishes a first anchor connection in a first radio access technology (RAT) with a master node in a wireless communication system. The UE establishes a second complimentary connection in a second RAT with a secondary node. The UE has a dual-connectivity (DC) configuration. The UE re-directs to establish a third connection in a third RAT, and the UE is disconnected from the first connection and the second connection. The UE re-establishes the first connection in the first RAT with the master node after disconnecting the third connection, and the UE provides assistant information of the second RAT to the master node. The UE restores the second connection in the second RAT with the assistant information via the reestablishment of the first connection.

In another embodiment, a master node establishes a first connection with a user equipment (UE) in a first Radio Access Technology (RAT) in a wireless communication system. The UE has a dual-connectivity (DC) configuration and a second connection with a secondary node in a second RAT. The master node re-directs the UE to establish a third connection in a third RAT, and the UE is disconnected from the first connection and the second connection. The master node re-establishes the first connection in the first RAT with the UE after disconnecting the third connection, and the master node receives assistance information of the second RAT from the UE. The master node restores the second connection for the UE using the assistance information.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an LTE and NR multi-RAT user equipment (UE) supporting fast Dual-Connectivity (DC) configuration after fallback in a 4G/5G network in accordance with one novel aspect.

FIG. 2 is a simplified block diagram of an LTE and NR multi-RAT UE in accordance with embodiments of the present invention.

FIG. 3 illustrates a block diagram and an overall flow chart of an implementation scheme of the present invention.

FIG. 4 illustrates a simple message flow between a UE and an LTE master node and an NR secondary node for supporting fast Dual-Connectivity (DC) configuration after fallback in a 4G/5G network.

FIG. 5 is a flow chart of a method of fast DC configuration after fallback from UE perspective in a 4G/5G network in accordance with one novel aspect.

FIG. 6 is a flow chart of a method of fast DC configuration after fallback from network perspective in a 4G/5G network in accordance with one novel aspect.

### DETAILED DESCRIPTION

Reference will now be made in detail to some embodiments of the invention, examples of which are illustrated in the accompanying drawings.

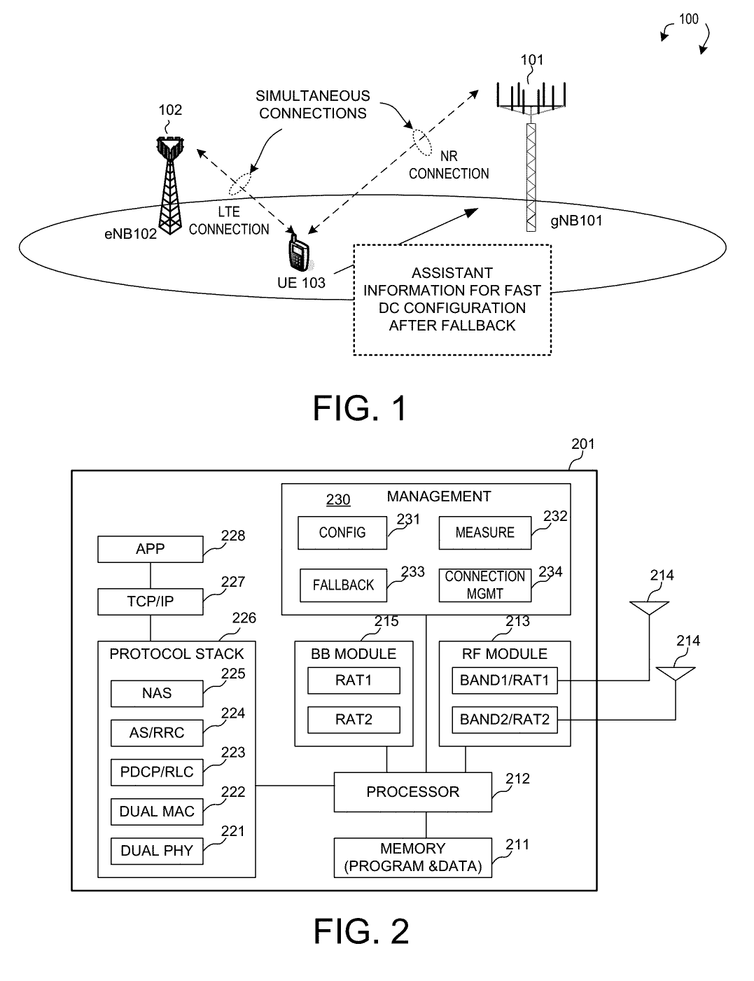

FIG. 1 illustrates an LTE and NR multi-RAT user equipment (UE) supporting fast Dual-Connectivity (DC) configuration after fallback in a 4G/5G network 100 in accordance with one novel aspect. In next generation 5G systems, a base station (BS) is referred to as gNB 101. In 4G LTE/LTE-A systems, an evolved universal terrestrial radio access network (E-UTRAN) includes a plurality of base stations, referred as evolved Node-Bs (eNodeBs or eNBs) (e.g., eNB 102) communicating with a plurality of mobile stations, referred as user equipments (UEs) (e.g., UE 102). The concept of carrier aggregation (CA) has been introduced to enhance the system throughput. With CA, two or more component carriers (CCs) are aggregated to support wider transmission bandwidth up to 100 MHz. The demand for higher bandwidth may require exploiting further on CA operation to aggregate cells from different base stations to serve a single UE, called inter-base station carrier aggregation (inter-eNB CA).

In DuCo or DC (dual connectivity), a UE is simultaneously connected to a master node (MN) and a secondary node (SN). Multiple serving cells are configured for the UE in DC mode. The serving cell from the MN is defined as Master Cell Group (MCG). The subset of serving cells that do not belong to MCG is defined as Secondary Cell Group (SCG). The UE could use radio resource provided by different RAT under Multi-RAT DC (MR-DC) architecture. EN-DC (EUTRAN-NR Dual Connectivity) is one possibility for MR-DC. If the UE has fallback to legacy RAT (e.g., 2G/3G) network for some specific purpose (e.g., for CSFB voice call), then the DC configuration is forced to be released. After the fallback procedure is completed (e.g., the voice call ended), the UE could return to a cell from the original MCG cells. But the UE has to wait the network configuration for adding the cells of SCG. It will take some time for the network to do the reconfiguration and bring the UE back to DC mode.

In accordance with one novel aspect, a method of UE supporting fast Dual-Connectivity (DC) configuration after fallback in a 4G/5G network is proposed. In the example of FIG. 1, UE 103 is connected to eNB 102 as its master node in LTE, and UE 103 is also connected to gNB 101 as its secondary node in NR. Due to a CSFB (circuit switched fallback) voice call, UE 103 fallbacks to 2G/3G and is forced to release from the DC configuration. After finishing the fallback operation, UE 103 provides assistant information when re-establishing its RRC connection back to the anchor RAT (LTE) of the DC configuration. With the assistant information, the network can perform fast DC configuration and resume transmission in DC mode. In one example, the DC configuration parameters before the fallback procedure are part of the assistance information. The DC configuration is the SCG configured by RRC, which includes the physical frequency and the physical cell ID of the current serving cells in the secondary node. In another example, UE 103 performs measurements over candidate NR cells that are configured by the network or autonomously determined by the UE. The measurement results are part of the assistant information. Note that the invention applies to both EN-DC (Master node is LTE) and NE-DC (Master node is NR).

FIG. 2 is a simplified block diagram of a UE for mobility management with power consumption enhancements in accordance with one novel aspect. UE 201 has an antenna (or antenna array) 214, which transmits and receives radio signals. A RF transceiver module (or dual RF modules) 213, coupled with the antenna, receives RF signals from antenna 214, converts them to baseband signals and sends them to processor 212 via baseband module (or dual BB modules) 215. RF transceiver 213 also converts received baseband signals from processor 212 via baseband module 215, converts them to RF signals, and sends out to antenna 214. Processor 212 processes the received baseband signals and invokes different functional modules to perform features in UE 201. Memory 211 stores program instructions and data to control the operations of UE 201.

UE 201 also includes a 3GPP/NR protocol stack module 226 supporting various protocol layers including NAS 225, AS/RRC 224, PDCP/RLC 223, dual MAC 222 and dual PHY 221, a TCP/IP protocol stack module 227, an application module APP 228. UE 201 with dual connectivity has two MAC entities. Two sets of upper layer stacks (RLC/PDCP) are configured for the MAC entities. RRC 224 controls the protocol stacks in corresponding to the MAC entities by communicating with the RRC entity of its serving master node.

UE 201 further comprises a management circuit 230 including a configuration circuit 231, a measurement circuit 232, a fallback circuit 233, and a connection management circuit 234. The circuits are function modules that can be configured and implemented by hardware, firmware, and software, or any combination thereof. The function modules, when executed by processor 212 (via program instructions and data contained in memory 211), interwork with each other to allow UE 201 to perform certain embodiments of the present invention accordingly. Configuration circuit 231 obtains configuration information from its serving master node and applies corresponding parameters, monitor circuit 232 performs radio link monitoring (RLM) and radio link failure (RLF) procedure, UE fallback circuit 233 performs a fallback procedure such that UE is released from the DC configuration and fallbacks to 2G/3G network. Connection management circuit 234 manages the connection establishment and re-establishment to LTE/4G and NR/5G networks. In one example, RF module 213 can be shared to support both band1/RAT1 and band2/RAT2, while BB module 215 can be shared to process both RAT1 and RAT2 simultaneously.

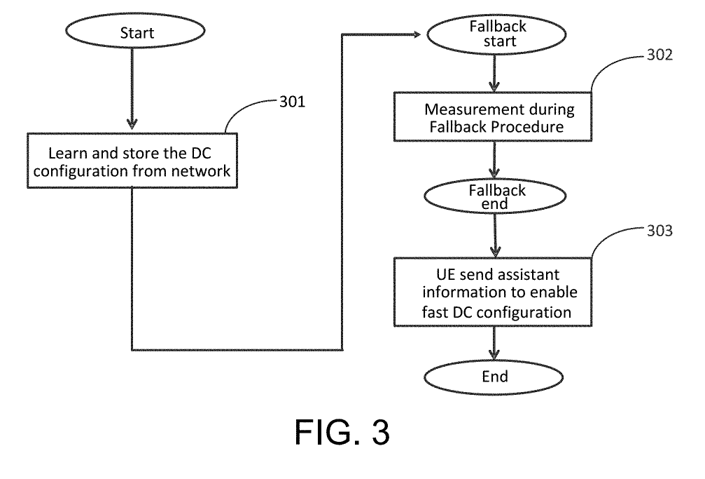

FIG. 3 illustrates a block diagram and an overall flow chart of an implementation scheme of the present invention. In the example of FIG. 3, a UE is initially connected to a master node in a first RAT (e.g., LTE) and also connected to a secondary node in a second RAT (e.g., NR) under DC configuration. In step 301, the UE learns and stores the DC configuration from the network. The UE maintains the stored information of NR cell(s) configuration as candidate SCG cell(s). If DC is configured before starting the fallback procedure, then the UE should also store the current SCG serving cell(s) information. The network could provide more NR cell(s) or NR frequencies in RRC command while starting the fallback procedure. Furthermore, the UE could record the serving cell information of several latest DC configurations in the stored information.

The UE then starts fallback and goes to step 302. In step 302, the UE performs measurements during the fallback procedure. The UE could monitor the quality of the stored candidate SCG cells (e.g., including originally configured NR cell in DC mode and newly configured NR cells during fallback RRC command) if UE capability is allowed to this. The UE could also detect some new candidate SCG cells during the fallback procedure if UE capability is allowed to this. The UE could store the cell ID of the new candidate cells with high quality. Note that the measurement for these 5G SCG cells should be low priority (e.g., with longer measurement period, etc.) such that the power consumption is acceptable.

After the fallback procedure is completed, the UE goes to step 303. In step 303, the UE sends assistant information to enable fast DC configuration. The assistant information could be an indication to tell the network that the UE is configured with DC configuration before the fallback to 2G/3G. The assistant information could be an information element (IE) in RRC message that contains some cell ID(s). The cell ID(s) is the suggested cell(s) for SCG configuration. The cell ID(s) could be determined by the stored information from step 301. Alternatively, the UE could include some UE-detected high-quality cells. All the suggested cells may optionally include a corresponding measurement result carried in the assistant information. As a result, the network can perform fast DC configuration and resume highspeed data transmission for the UE soon after the fallback procedure.

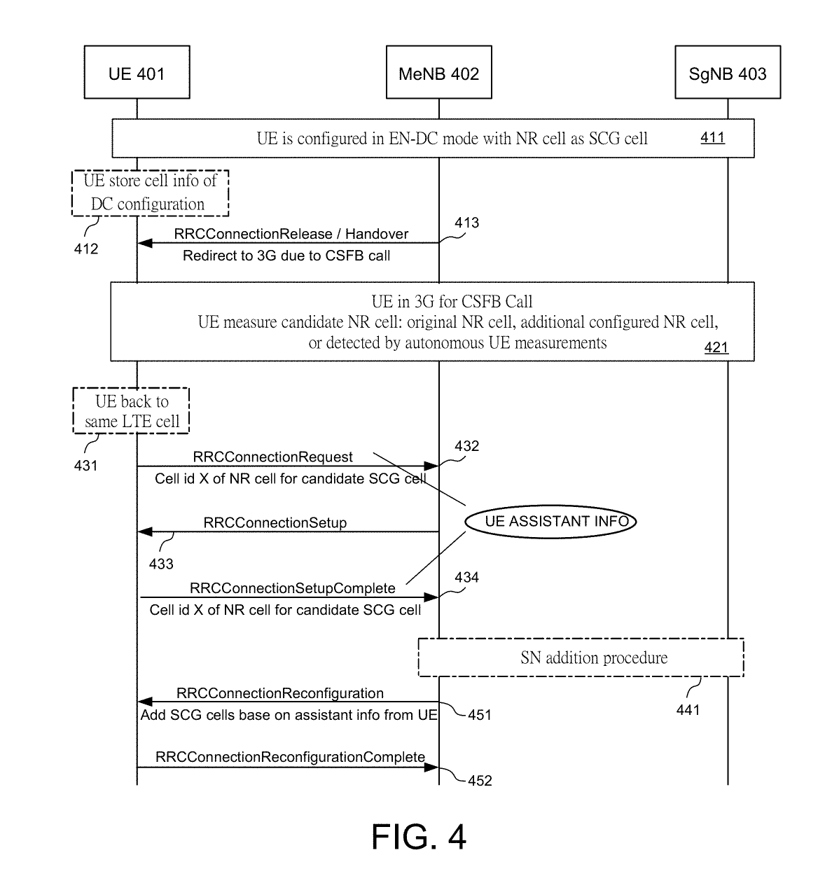

FIG. 4 illustrates a simple message flow between a UE and an LTE master node and an NR secondary node for supporting fast Dual-Connectivity (DC) configuration after fallback in a 4G/5G network. UE 401 is a multi-RAT UE supporting EN-DC DuCo configuration. In step 411, UE 401 is configured in EN-DC mode, connecting to master eNB node MeNB 402 in an LTE cell belonging to MCG, and also connecting to secondary gNB node SgNB 403 in one or more NR cells belonging to SCG. UE 401 establishes one RRC connection with MeNB 402 for control and configuration. In step 412, UE 401 stores the cell information of the DC configuration. UE 401 maintains the stored information of the NR cell(s) configuration as candidate SCG cell(s). In step 413, UE 401 is redirected to fall back to 3G network due to CSFB voice call. The redirection can be achieved by sending UE 401 an RRC connection release message, or by sending UE 401 a handover command. Further, the fallback command may also comprise measurement request for additional NR cells or NR frequencies as candidate SCG cell(s). In step 421, UE 401 fallbacks to 3G network for the CSFB voice call. During the fallback, UE 401 performs measurements for candidate SCG cell(s), which include the original NR cell(s) before fallback, the additional configured NR cell(s), and/or detected NR cells by autonomous UE measurements.

After the fallback is completed, in step 431, UE 401 returns to an LTE cell from the original MCG cells. In step 432, UE 401 sends an RRC connection request message to its master node MeNB 402. In one advantageous aspect, UE 401 also sends UE assistant information to MeNB 402 via the RRC message. The UE assistant information comprises a set of parameters of the DC configuration before the re-directing. The UE assistance information may also comprise cell IDs for candidate SCG cells suggested by the UE for SCG configuration and may include a measurement result for each candidate SCG cell. In step 433, UE 401 receives an RRC connection setup message from MeNB 402. In step 434, UE 401 sends an RRC connection setup complete message to MeNB 402. Instead of providing the UE assistant information via the RRC connection request message, the UE assistant information may be provided via the RRC connection setup complete message. In yet another alternative, the UE assistant information may be provided by a new RRC message after the RRC connection setup procedure. Further, if UE 401 is handover from the 3G network to LTE network in step 431, then the UE assistant information could be included in an RRC connection reconfiguration complete message during the handover procedure back to LTE. In step 441, MeNB 402 performs the secondary node (SN) addition procedure with SgNB 403. In step 451, MeNB 402 sends an RRC connection reconfiguration message to UE 401 for adding SCG cell(s) based on the assistant information provided by the UE. Note that without the assistance information, MeNB 402 has to configure UE 401 for measurements over NR cells and wait for measurement report from UE 401. With the assistant information, step 441 is started earlier and the delay between step 434 and step 451 is reduced. As a result, UE 401 can be configured for adding NR cells of SCG quickly. In step 452, UE 401 sends an RRC connection reconfiguration complete message back to MeNB 402 to complete the EN-DC configuration.

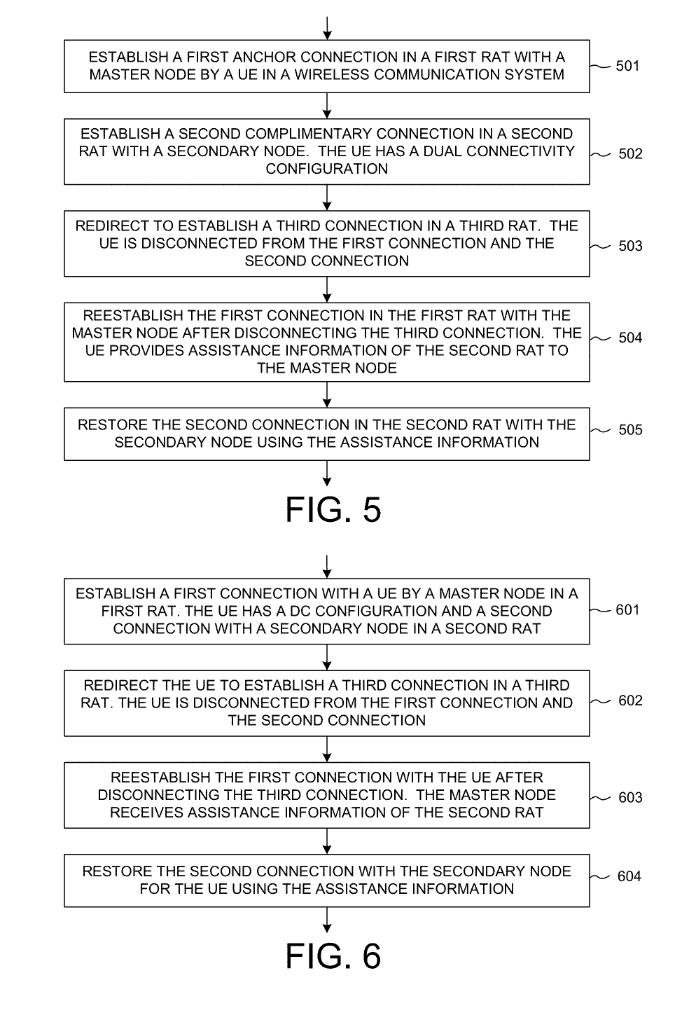

FIG. 5 is a flow chart of a method of fast DC configuration after fallback from UE perspective in a 4G/5G network in accordance with one novel aspect. In step 501, a UE establishes a first anchor connection in a first radio access technology (RAT) with a master node in a wireless communication system. In step 502, the UE establishes a second complimentary connection in a second RAT with a secondary node. The UE has a dual-connectivity (DC) configuration. In step 503, the UE re-directs to establish a third connection in a third RAT, and the UE is disconnected from the first connection and the second connection. In step 504, the UE re-establishes the first connection in the first RAT with the master node after disconnecting the third connection, and the UE provides assistance information of the second RAT to the master node. In step 505, the UE restores the second connection with the assistance information via the reestablishment of the first connection.

FIG. 6 is a flow chart of a method of fast DC configuration after fallback from network perspective in a 4G/5G network in accordance with one novel aspect. In step 601, a master node establishes a first connection with a user equipment (UE) in a first Radio Access Technology (RAT) in a wireless communication system. The UE has a dual-connectivity (DC) configuration and a second connection with a secondary node in a second RAT. In step 602, the master node re-directs the UE to establish a third connection in a third RAT, and the UE is disconnected from the first connection and the second connection. In step 603, the master node re-establishes the first connection in the first RAT with the UE after disconnecting the third connection, and the master node receives assistance information of the second RAT from the UE. In step 604, the master node restores the second connection for the UE using the assistance information.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
establishing a first anchor connection in a first radio access technology (RAT) with a master node by a user equipment (UE) in a wireless communication system;
establishing a second complimentary connection in a second RAT with a secondary node, wherein the UE has a dual-connectivity (DC) configuration;
re-directing to establish a third connection in a third RAT, wherein the UE is disconnected from the first connection and the second connection;
re-establishing the first connection in the first RAT with the master node after disconnecting the third connection, wherein the UE provides assistance information of the second RAT to the master node; and
restoring the second connection in the second RAT with the assistance information via the reestablishment of the first connection.

2. The method of claim 1, wherein the first RAT is over 4G/LTE EUTRAN (evolved universal terrestrial radio access network), and wherein the second RAT is over 5G/NR (new radio).

3. The method of claim 1, wherein the UE measures a signal quality of a candidate cell of the second RAT after re-directing to the third RAT.

4. The method of claim 3, wherein the candidate cell is an original cell, an additional configured cell, or a detected cell by autonomous UE measurements.

5. The method of claim 3, wherein the assistance information comprises a cell ID and a measurement report of the candidate cell.

6. The method of claim 1, wherein the assistance information comprises a set of parameters of the DC configuration before the re-directing.

7. The method of claim 1, wherein the re-establishing of the first connection involves a connection establishment procedure to the first RAT or a connection handover procedure from the third RAT to the first RAT.

8. The method of claim 1, wherein the UE provides the assistance information via a radio resource control (RRC) message that is a connection setup complete, a connection request, a connection reconfiguration complete, or a UE information response.

9. A user equipment (UE), comprising:
a first RF transceiver that establishes a first anchor connection in a first radio access technology (RAT) with a master node in a wireless communication system;
a second RF transceiver that establishes a second complimentary connection in a second RAT with a secondary node, wherein the UE has a dual-connectivity (DC) configuration;
a fallback circuit that re-directs the UE to establish a third connection in a third RAT, wherein the UE is disconnected from the first connection and the second connection; and
a connection management circuit that re-establishes the first connection in the first RAT with the master node after disconnecting the third connection, wherein the UE provides assistance information of the second RAT to the master node, and wherein the UE restores the second connection in the second RAT with the assistance information via the reestablishment of the first connection.

10. The UE of claim 9, wherein the first RAT is over 4G/LTE EUTRAN (evolved universal terrestrial radio access network), and wherein the second RAT is over 5G/NR (new radio).

11. The UE of claim 9, wherein the UE measures a signal quality of a candidate cell of the second RAT after re-directing to the third RAT.

12. The UE of claim 11, wherein the candidate cell is an original cell, an additional configured cell, or a detected cell by autonomous UE measurements.

13. The UE of claim 11, wherein the assistance information comprises a cell ID and a measurement report of the candidate cell.

14. The UE of claim 9, wherein the assistance information comprises a set of parameters of the DC configuration before the re-directing.

15. The UE of claim 9, wherein the re-establishing of the first connection involves a connection establishment procedure to the first RAT or involves a connection handover procedure from the third RAT to the first RAT.

16. The UE of claim 9, wherein the UE provides the assistance information via a radio resource control (RRC) message that is a connection setup complete, a connection request, a connection reconfiguration complete, or a UE information response.

17. A method comprising:
establishing a first connection with a user equipment (UE) by a master node in a first Radio Access Technology (RAT) in a wireless communication system, wherein the UE has a dual-connectivity (DC) configuration and a second connection with a secondary node in a second RAT;
re-directing the UE to establish a third connection in a third RAT, wherein the UE is disconnected from the first connection and the second connection;
re-establishing the first connection in the first RAT with the UE after disconnecting the third connection, wherein the master node receives assistance information of the second RAT from the UE; and
restoring the second connection for the UE using the assistance information.

18. The method of claim 17, wherein the first RAT is over 4G/LTE EUTRAN (evolved universal terrestrial radio access network), and wherein the second RAT is over 5G/NR (new radio).

19. The method of claim 17, wherein the master node sends a measurement request to the UE for measuring a candidate cell of the second RAT upon the re-directing.

20. The method of claim 19, wherein the assistance information comprises a cell ID and a measurement report of the candidate cell.
